(19) United States
(12) Patent Application Publication
(10) Pub. No.: US 2012/0012714 A1
(43) Pub. Date: Jan. 19, 2012

(54) DUAL-ARM CABLE-MANAGEMENT SYSTEM

(76) Inventors: Brandon Rubenstein, Loveland, CO (US); Eric Peterson, Woodinville, WA (US)

(21) Appl. No.: 13/258,784

(22) PCT Filed: Apr. 28, 2009
(86) PCT No.: PCT/US09/02582

§ 371 Date: Sep. 22, 2011

(51) Int. Cl. F16L 3/22; F16L 3/08

(52) U.S. Cl. 248/68.1; 248/70

(57) ABSTRACT

One embodiment of the present invention employs two articulated cable-management arms, each articulated cable-management arm pivotally mounted, at a first end, to a system frame or rack and pivotally mounted, at a second end, to a component-system enclosure or sliding component-system-enclosure mount. The articulated cable-management arms provide mechanical channels through which cables connected to the back of a component-system enclosure are routed together to a structural member of the rack or frame.

### TECHNICAL FIELD

The present invention is related to mounting systems for components of multi-component computer and other electronic systems and, in particular, to a dual-arm cable-management system for organizing power, communications, and other cables connected to a component system.

### BACKGROUND OF THE INVENTION

Many different types of modular computer systems and other electronic systems include multiple component systems, each component system comprising internal components, such as printed circuit boards, mass-storage devices, power supplies, and other sub-modules organized and interconnected within a component-system enclosure. The multiple system components are generally mounted in a frame or rack to create a single, physical, multi-component system or multi-component subsystem of an even larger modular system. In general, each component-system enclosure provides, generally at the back of the component-system enclosure, multiple ports to which a variety of different types of cables are connected, the cables providing power input from external power sources or internal power-supply components, power output from power-supply components, intra-system communications paths, and communications paths to external routers and other communications devices, and internal data paths that interconnect mass-storage devices to data-processing engines and other internal components. Often, technical advances provide higher-bandwidth interconnections that allow for dramatic, short-term reductions in the number of cables and cable sizes, but, in general, as the system components continue to grow increasingly complex and provide ever-increased numbers of processors, mass-storage devices, and other such computational resources, the number of cables continues to increase despite such technical advances.

Cable management is a significant problem in designing, building, and, perhaps most importantly, maintaining and managing multi-component systems in which components are mounted within frames, racks, or other physical structures. A A number of cable-management systems have been developed to address these problems. Designers, manufacturers, administrators, and users of multi-component systems continue to seek improved cable-management systems to address new and remaining problems in cable management.

### BRIEF DESCRIPTION OF THE DRAWINGS

FIG. 1 shows a representation of a single-column, rack-mounted, multi-component computing system.

FIG. 2 shows the basic structure of the rack used for mounting components in the exemplary rack-mounted system shown in FIG. 1.

FIG. 3 shows a component system mounted within a bay of a rack mount for component systems.

FIG. 4 shows the component system and rack-mount bay, of FIG. 3, with the slideable mounting apparatus moved forward, to expose the bulk of the component system.

FIG. 5 shows the component system within the bay of a rack mount, of FIGS. 3 and 4, from the back side.

FIG. 6 illustrates a mechanical cable-management system.

FIG. 7 shows the mechanical cable-management system, shown in FIG. 6, with a single cable threaded through the cable-management arm.

FIG. 8 shows the mechanical cable-management system of FIG. 7 when the component system has been slideably extracted from the bay.

FIG. 9 illustrates the general path of cabling connected to component systems in a rack-mounted multi-component system.

FIG. 10 provides a perspective view of a dual-articulated-cable-management-arm cable-management system that represents one embodiment of the present invention.

FIG. 11 shows the dual-articulated-cable-management-arm cable-management system that represents one embodiment of the present invention from the top, with the slideable component-enclosure mounting apparatus positioned fully within the bay of the rack.

FIGS. 12A-B illustrate the dual-articulated-cable-management-arm cable-management system that represents one embodiment of the present invention, shown in FIGS. 10 and 11, as the slideable component-system mounting assembly is pulled forward and out from the bay.

FIGS. 13A-B illustrate an additional feature of the dual-articulated-cable-management-arm cable-management system that represents one embodiment of the present invention.

### DETAILED DESCRIPTION OF THE INVENTION

One embodiment of the present invention employs two articulated cable-management arms, each articulated cable-management arm pivotally mounted, at a first end, to a system frame or rack and pivotally mounted, at a second end, to a component-system enclosure or sliding component-system-enclosure mount. The articulated cable-management arms provide mechanical channels through which cables connected to the back of a component-system enclosure are routed together to a structural member of the rack or frame. A first articulated cable-management arm is mounted to a structural member on a first side of the back of the component-system enclosure and a second articulated cable-management arm is mounted to a structural member on the opposite side of the back of component-system enclosure. The first articulated cable-management arm is mounted below the second articulated cable-management arm, and both articulated cable-management arms flex about a central pivot to extend forward into the frame or rack as the component system is slid forward to a position in which the component system is partially or completely external from the frame or rack, with cables remaining connected to the component system and directed through the articulated cable-management arms to cable paths along both structural members of the frame or rack.

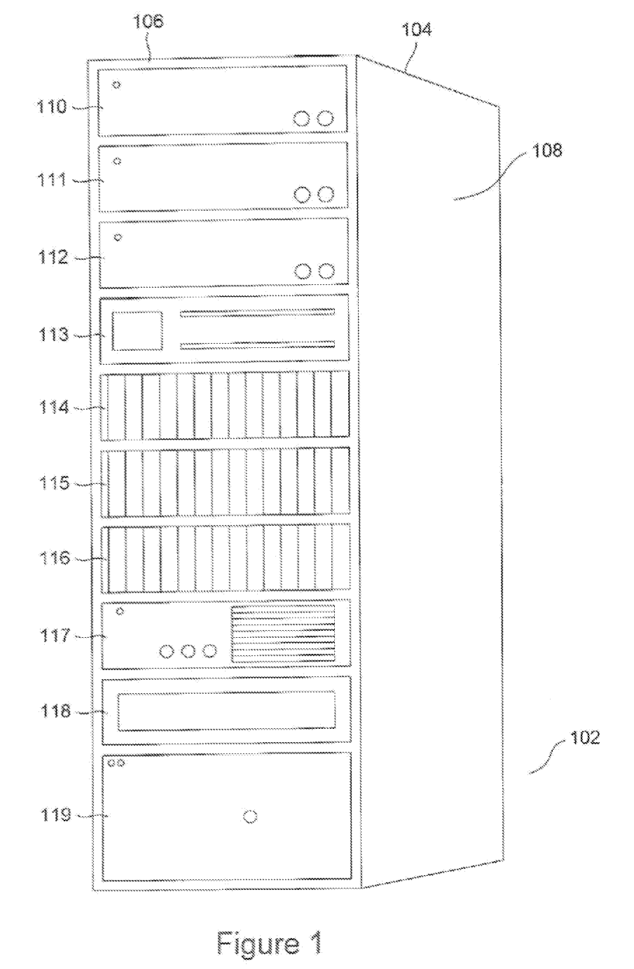

FIG. 1 shows a representation of a single-column, rack-mounted, multi-component computing system. The rack-mounted system 102 includes a rack 104 consisting of structural members, such as horizontal structural member 106, and, optionally, a sheet-metal covering 108 on one or both sides. The rack provides a number of bays 110-119 in which component systems are mounted. In the exemplary rack-mounted system shown in FIG. 1, blade-server-containing components arc mounted in bays 114-116, a large non-stop power supply is mounted in bay 119, and the remaining bays contain additional types of component systems, such as mass-storage-device-based component systems and communications component systems.

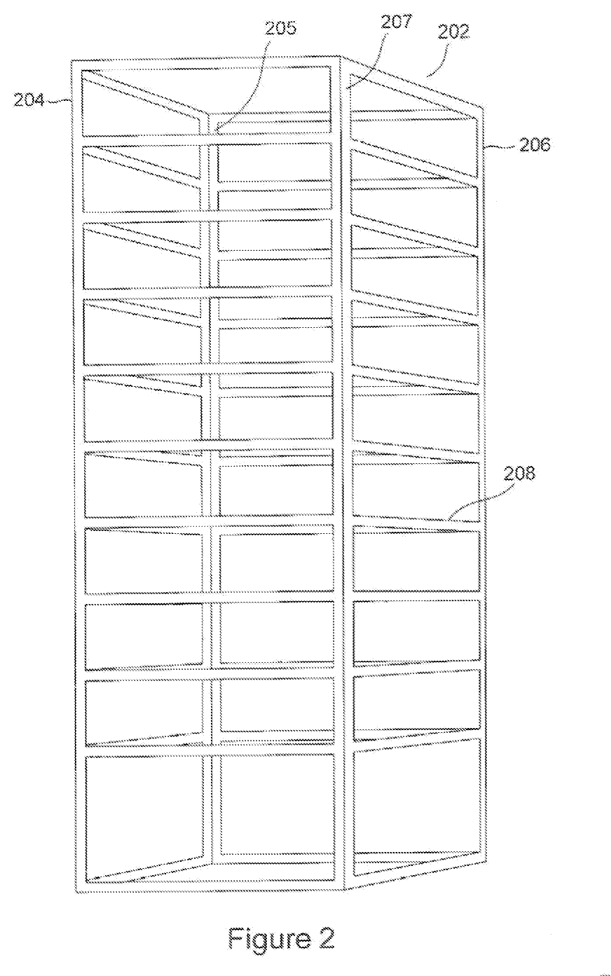

FIG. 2 shows the basic structure of the rack used for mounting components in the exemplary rack-mounted system shown in FIG. 1. The rack 202 includes four column structural members 204-207 and a large number of horizontal structural members, such as structural member 208, which define the various bays in which components arc mounted. A variety of different configurations featuring different geometries and numbers of structural members are possible.

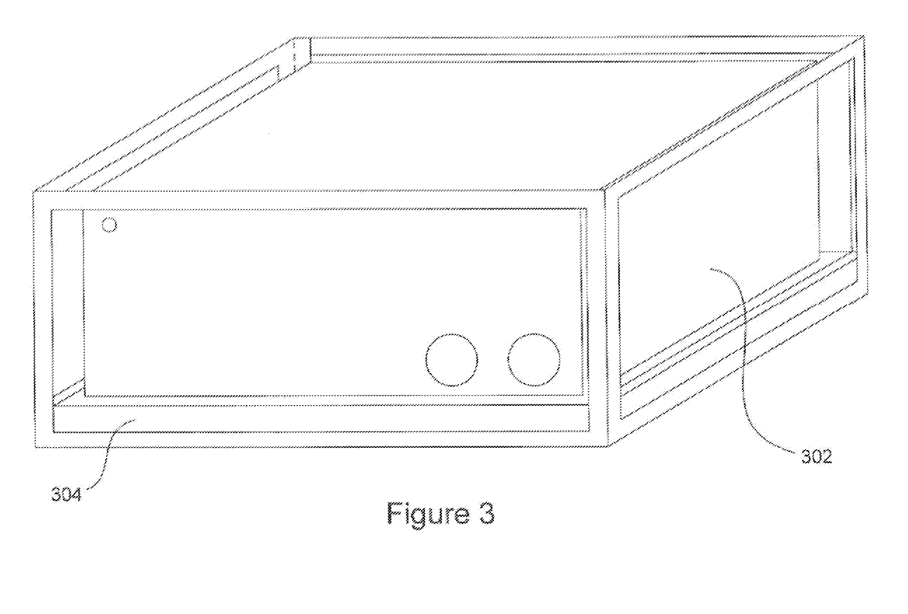

FIG. 3 shows a component system mounted within a bay of a rack mount for component systems. In FIG. 3, and in subsequent figures, only those structural members of the rack mount that define the bay arc shown. The vertical structural members generally continue both vertically upward and vertically downward, except for the top and bottom bays. The component system 302 is generally affixed to a slideable mounting apparatus 304. Note that, in FIG. 3 and in subsequent figures, the slideable mounting apparatus is shown simply as a slideable shelf-like tray. In many rack-mount multi-component systems, the slideable mounting apparatus is a more complex mechanical system.

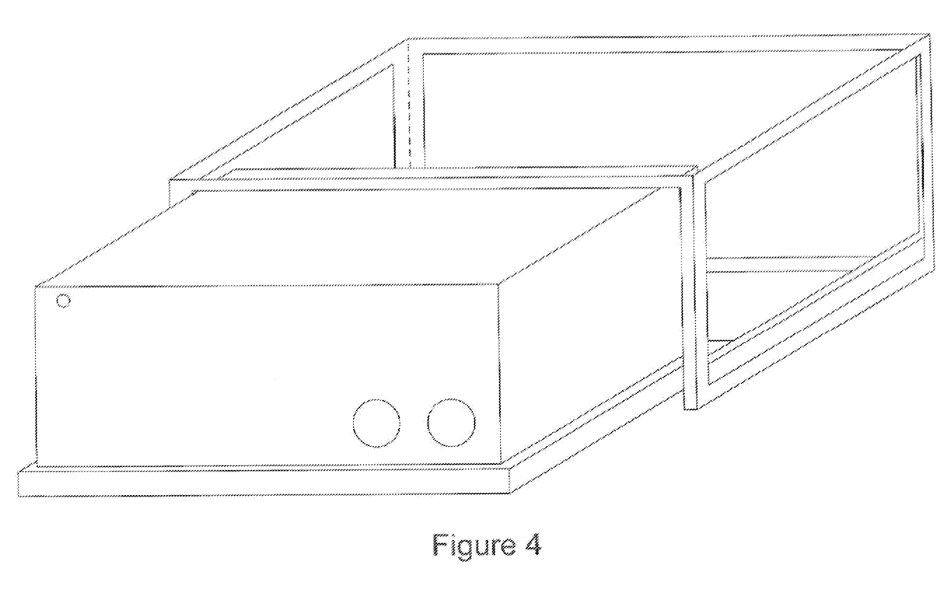

FIG. 4 shows the component system and rack-mount bay, of FIG. 3, with the slideable mounting apparatus moved forward, to expose the bulk of the component system. Depending on the design of the slideable mounting apparatus, the component system may be partially or completely removed from the bay when the slideable mounting apparatus is maximally extended from the bay.

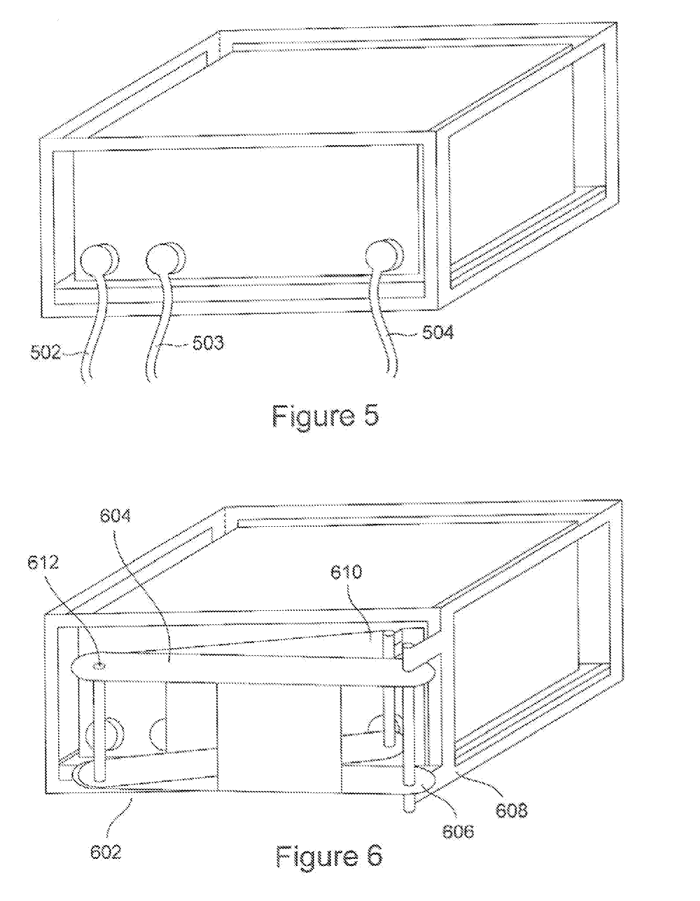

FIG. 5 shows the component system within the bay of a rack mount, of FIGS. 3 and 4, from the back side. In general, a number of ports are present on the backside of the component system, to which multiple cables 502-504 are attached. In FIG. 5, three cables are shown attached to the component system, but, in actual systems, many more cables may be attached to a given component system. Were the cables allowed to simply dangle downward, as shown in FIG. 5, the back of a rack-mount multi-component system would appear to be a forest of dangling cables, which would present significant maintenance and management problems. The cables may become entangled with one another, preventing component systems from being slideably removed from bays, and cable routing between component systems within the multi-component system as well as from the multi-component system to external power sources and other external systems, would be increasingly difficult, over time.

FIG. 6 illustrates a mechanical cable-management system. As shown in FIG. 6, a mechanical cable-management system 602 may be mounted to the back of the bay of a rack mount in order to provide a mechanical guide for organizing the cables connected to the component system within the bay. The cable management system comprises an articulated cable-management arm 604 that is pivotally mounted, at a first end 606, to the rack mount frame 608 and that is pivotally mounted, at a second end 610, to the component system, to the slideable mounting apparatus, or to both the component system and slideable mounting apparatus. The articulated cable-management arm is articulated via a third pivot 612 positioned at an approximate midpoint of the articulated cable-management arm when the articulated cable-management arm is fully extended, the third pivot dividing the articulated cable-management arm into two segments.

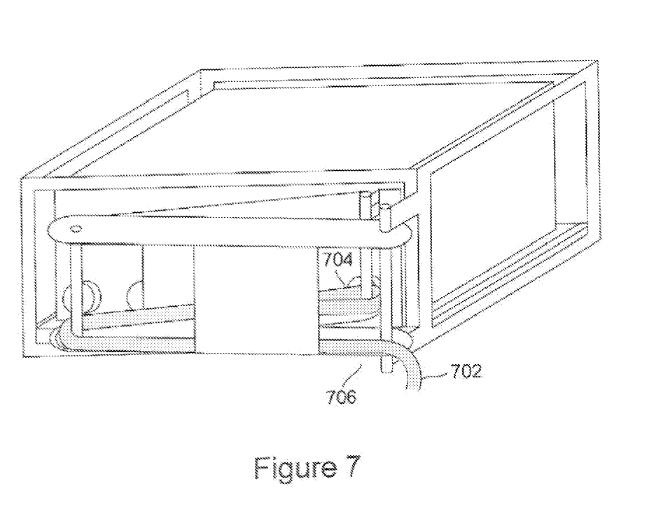

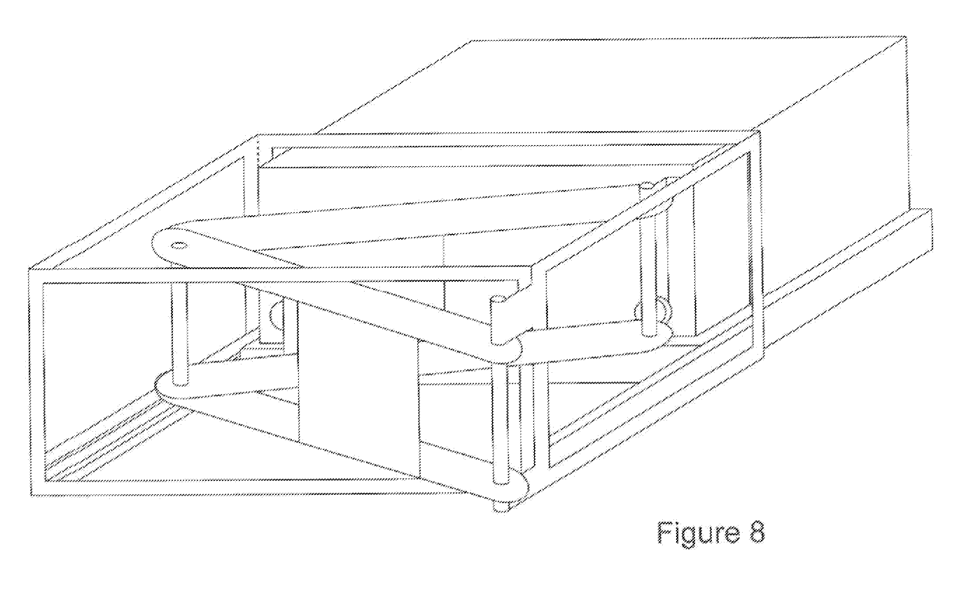

FIG. 7 shows the mechanical cable-management system, shown in FIG. 6, with a single cable threaded through the cable-management arm. The cable 702 is threaded into the articulated cable-management arm near the second end 704 and through the cable-management arm to exit the mechanical cable-management system near the second end 706. The exact placement and routing path of a cable may vary, depending on the structure of the cable management system and on methods of use practiced by the multi-component system designers and administrators. In general, all of the cables connected to the component system are collected within the articulated cable-management arm and, upon exiting the articulated cable-management arm near the first end 706, are attached to, and directed downward or upward along, a vertical member of the rack. FIG. 8 shows the mechanical cable-management system of FIG. 7 when the component system has been slideably extracted from the bay. The been slideably extracted from the bay. The articulated cable-management arm has partially unfolded within the bay, in scissors-like fashion, as the slideable mounting apparatus has been pulled forward.

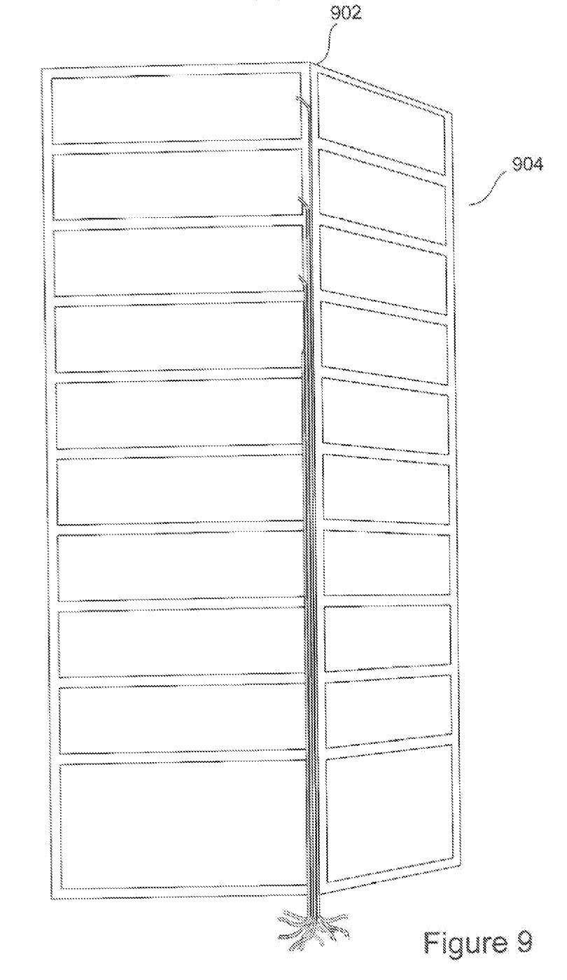

FIG. 9 illustrates the general path of cabling connected to component systems in a rack-mounted multi-component system. As shown in FIG. 9, the cabling is generally attached to a single vertical structural member 902 of the rack or frame 904 in which the component systems are mounted, since the cable-management systems illustrated in FIGS. 6-8 are generally attached to a single vertical member. While the mechanical cable-management system illustrated in FIGS. 6-8 provides useful cable-management functionality, and avoids a tangled mass of cables at the back of the system, there are problems associated with the cable-management system. One problem is that most or all of the cabling is directed along a single vertical structural member of the rack or frame, as shown in FIG. 9. This may result in a very large bundle of cables from which it may be difficult to extract particular cables for replacement and to which it may be difficult to add additional cables. Furthermore, because the cable-management systems are mounted to a single structural member, cabling length for cables attached to ports near that structural member may need to be increased, due to the increased path length attendant with routing the cable into the articulated cable-management arm, since the entry point is located near one side of the back of the component-system enclosure. In certain cases, this additional path length, added to the direct path length between the port on the component-system enclosure and the destination of the cable, may exceed an overall maximum cable length for particular types of interconnections. While two vertical structural members might be used for cable routing by attaching the articulated cable-management arms to alternating sides of the component-system bays, the problem of increased cable path length for ports opposite from the entry point for a articulated cable-management arm would not be remedied, and additional routing problems may arise due to the need to route all types of cables from both sides of the rack or frame.

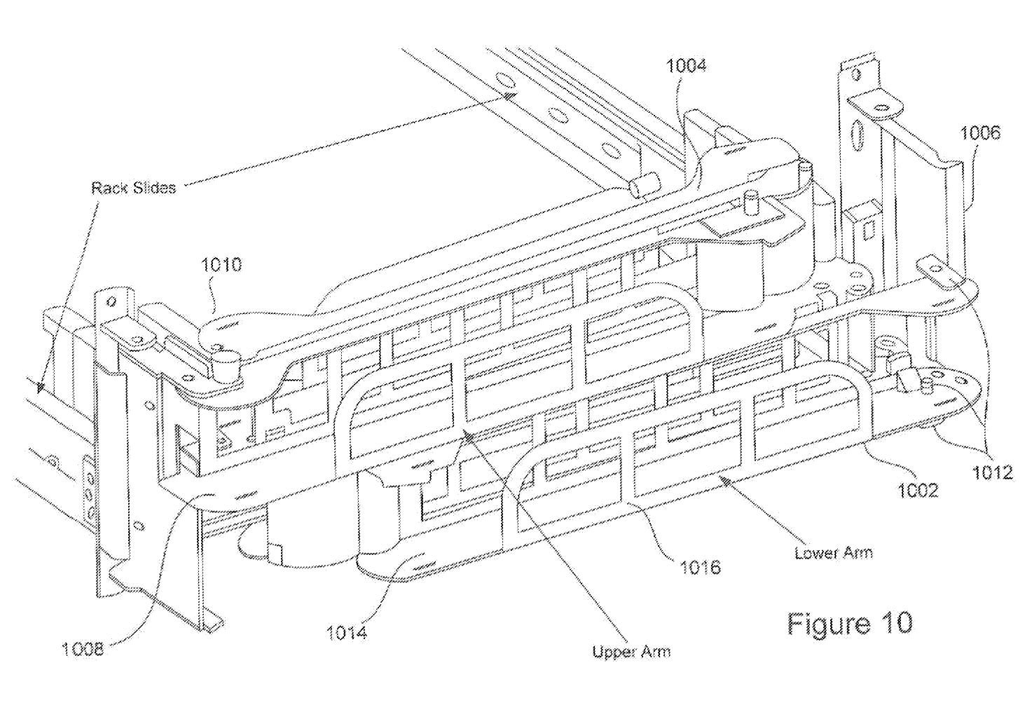

Embodiments of the present invention provide cable-management systems that address the above-described problems. FIG. 10 provides a perspective view of a dual-articulated-cable-management-arm cable-management system that represents one embodiment of the present invention. As shown in FIG. 10, the dual-articulated-cable-management-arm cable-management system includes a first, lower articulated cable-management arm 1002 and a second, upper articulated cable-management arm 1004. The lower articulated cable-management arm is pivotally attached to the right-hand vertical structural member 1006 and the second articulated cable-management arm is pivotally attached to the left-hand vertical member of the rack 1008. The second articulated cable-management arm is pivotally attached to the left-hand portion 1010 of a slideable mounting assembly and the first articulated cable-management arm is pivotally attached to the right-hand side 1012 of the slideable component-system mounting assembly. Each of the dual articulated cable-management arms 1002 and 1004 is approximately half-height with respect to the articulated cable-management-arm of previous single-articulated-cable-management-arm cable-management systems, such as that shown in FIGS. 6-8, and each features a horizontal tray and two vertical, fence-like cable guides, such as tray 1014 and fence-like cable guide 1016.

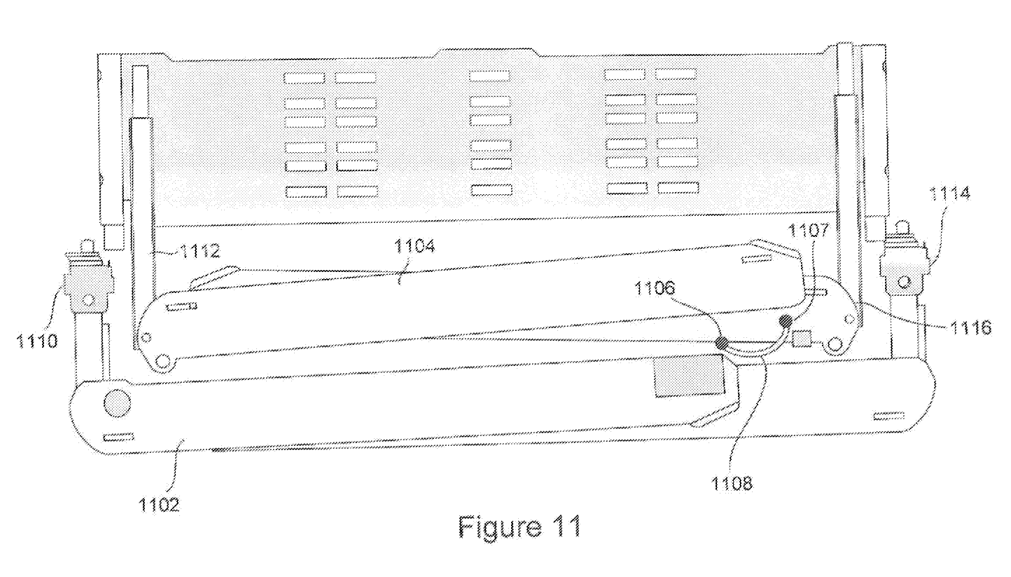

FIG. 11 shows the dual-articulated-cable-management-arm cable-management system that represents one embodiment of the present invention from the top, with the slideable component-enclosure mounting apparatus positioned fully within the bay of the rack. The upper articulated cable-management arm is shown to include a first segment 1102 connected to a second segment 1104 through a two-pivot 1106-1107 and pivot-control-link 1108 assembly. The upper articulated cable-management arm is attached to the left-hand vertical rack column through an attachment 1110 and is attached to the slideable component-system mounting assembly through a second attachment 1112. Similarly, the lower articulated cable-management arm is attached to the right-hand vertical member through attachment 1114 and to the right-hand side of the slideable component-system mounting assembly through attachment 1116.

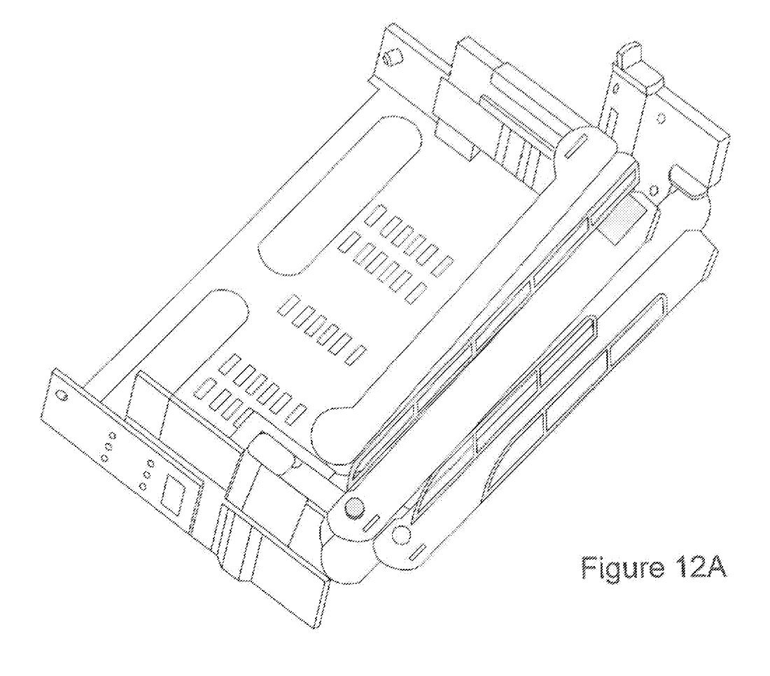

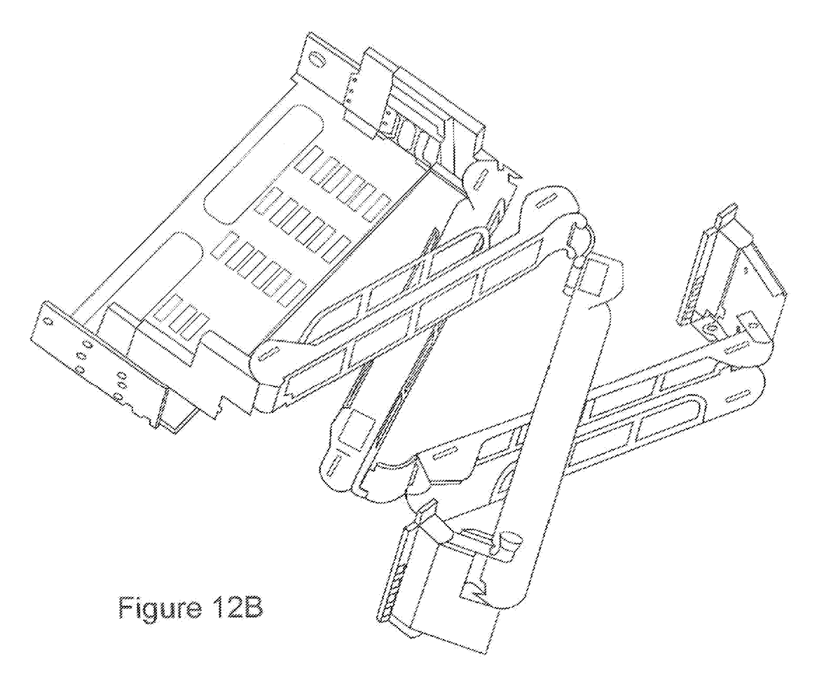

FIGS. 12A-B illustrate the dual-articulated-cable-management-arm cable-management system that represents one embodiment of the present invention, shown in FIGS. 10 and 11, as the slideable component-system mounting assembly is pulled forward and out from the bay. Each of the two articulated cable-management arms extend, scissor-like, into the bay as the slideable component-system mounting assembly is pulled forward.

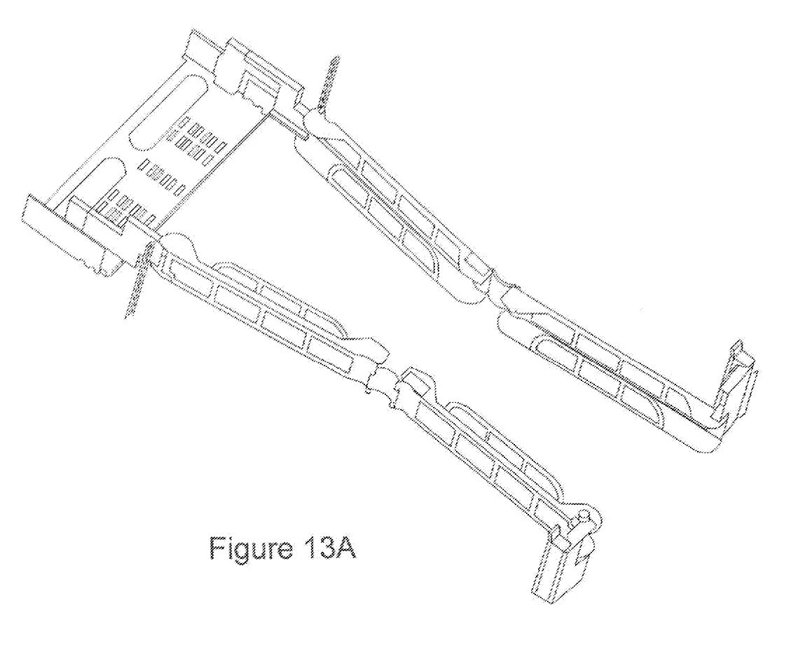

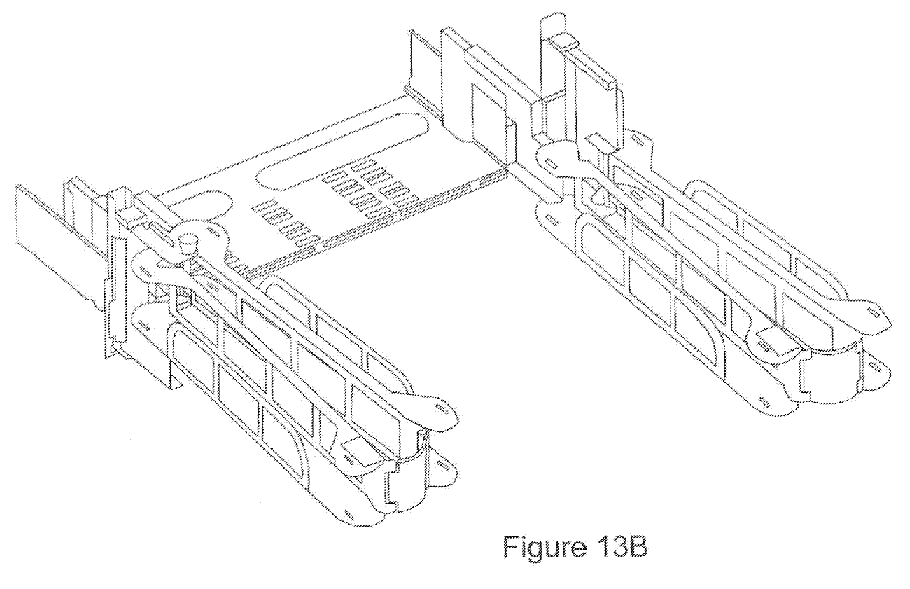

FIGS. 13A-B illustrate an additional feature of the dual-articulated-cable-management-arm cable-management system that represents one embodiment of the present invention. As shown in FIG. 13A, a locking pin can be removed from the dual-pivot articulations of each articulated cable-management arm so that both articulated cable-management arms can be swung out from the positions shown in FIG. 11 to expose the back side of a component system mounted within the slideable component-system mounting assembly. In essence, the locking pin, when in place, prevents segments being rotated with respect to one another by more than 90°, while, when removed, the segments can be rotated through 90° to 180° or more.

The dual-articulated-cable-management-arm cable-management system that represents an embodiment of the present invention allows cabling connected to component systems to be routed along both vertical frame or rack members at either side of the back of component-system bays within a rack or frame. Thus, the cables can be better distributed along structural members. Moreover, no port of a component system is more than half the width of the component system away from an entry point to one of the two half-height cable-management arms, ameliorating certain cable-path-length constraints and problems. The dual-arbitrated-cable-management-arm mechanical cable-management system of the present invention allows for partitioning all of the cables emanating from a component system into two groups to facilitate cable organization. For example, power cables may be routed through one of the two articulated cable-management arms, while communications cables may be routed through the other, and this organization can be used for all component systems, so that a first vertical structural member can be used to route one or a number of types of cables different from the type or types of cables routed along a second vertical structural member.

Although the present invention has been described in terms of particular embodiments, it is not intended that the invention be limited to these embodiments. Modifications will be apparent to those skilled in the art. For example, each of the two example, each of the two articulated cable-management arms of the mechanical cable-management system that represents one embodiment of the present invention may be constructed to provide solid, open-fence-like, or other types of cable guides and guide floors. While a two-pivot articulation is employed in the described embodiment, additional types of articulations may be used, including single-pivot articulations and flexible joints made from elastimers and other types of flexible materials. Various types of pivotal mounting mechanisms can be used to affix the articulated cable-management arms both to the rack or frame of a multi-component system as well as to mounting assemblies for mounting component systems, to component systems, or both to component systems and mounting assembles.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A cable-management system comprising:
a first, lower articulated-cable-management arm having a first end that pivotably attaches to a first structural member of a multi-component-system rack, a second end that pivotably attaches to one of the component system, a slidable component-system-mounting apparatus, or both the component system and the slidable component-system-mounting apparatus, cable guides, and an articulation approximately midway between the first and second ends; and
a second, upper articulated-cable-management arm having a first end that pivotably attaches to a second structural member of the multi-component-system rack, a second end that pivotably attaches to one of the component system, the slidable component-system-mounting apparatus, or both the component system and the slidable component-system-mounting apparatus, cable guides, and an articulation approximately midway between the first and second ends;
wherein the first, lower articulated-cable-management arm and the second, upper articulated-cable-management arm have heights that allow the first, lower articulated-cable-management arm to be mounted below the second, upper articulated-cable-management arm within a single bay of a rack-mounted multi-component system.

2. The cable-management system of claim 1 wherein each of the first, lower articulated-cable-management arm and the second, upper articulated-cable-management arm include a first segment and a second segment joined by the articulation.

3. The cable-management system of claim 2
wherein the first segment of the first, lower articulated-cable-management arm pivotably attaches to the first structural member of the multi-component-system rack at the first end and pivotably attaches to the second segment of the first, lower articulated-cable-management arm through the articulation;
wherein the second segment of the first, lower articulated-cable-management arm pivotably attaches, at the second end, to one of the component system, the slidable component-system-mounting apparatus, or both the component system and the slidable component-system-mounting apparatus;
wherein the first segment of the second, upper articulated-cable-management arm pivotably attaches to the second structural member of the multi-component-system rack at the first end and pivotably attaches to the second segment of the second, upper articulated-cable-management arm through the articulation; and
wherein the second segment of the second, upper articulated-cable-management arm pivotably attaches, at the second end, to one of the component system, the slidable component-system-mounting apparatus, or both the component system and the slidable component-system-mounting apparatus.

4. The cable-management system of claim 2 or 3 wherein each first segment and each second segment includes a tray and two vertical sides that act as cable guides as well as, together with the tray, a rigid articulated-cable-management-arm segment.

5. The cable-management system of claim 2 or 3 wherein the articulation of the first segment of the first, lower articulated-cable-management arm and the second, upper articulated-cable-management arm includes:
a first pivot through which the articulation pivotably attaches to the first segment of the first segment of the first, lower articulated-cable-management arm or the second, upper articulated-cable-management arm;
a second pivot which the articulation pivotably attaches to the second segment of the first segment of the first, lower articulated-cable-management arm or the second, upper articulated-cable-management arm; and
a curved pivot link that joins the first pivot with the second pivot.

6. The cable-management system of claim 2 or 5 wherein the pivotal attachments are implemented through pivots, each pivot comprising one of:
a mounted, vertical pin that comprises an axis of rotation in the horizontal plane;
a rotatable rivet that comprises an axis of rotation in a horizontal plane; and
a flexible material that allows for bending, in the horizontal plane, about an approximately vertical axis.

7. The cable-management system of claim 2 or 5 wherein each articulation further includes a locking pin that prevents rotation of the pivotably attached first segment with respect to the pivotably attached second segment by more than 90°.

8. The cable-management system of claim 7 wherein, when the locking pin is removed or disengaged, the pivotably attached first segment can be rotated by up to approximately 180° with respect to the pivotably attached second segment so that the articulated-cable-management arm that includes the first and second segments can be folded away from the back of the component system.

9. A cable-management system installed on a multi-component system rack, the cable-management system comprising:
a first, lower articulated-cable-management arm that is pivotably attached to a first structural member of the multi-component-system rack and pivotably attached to one of the component system, a slidable component-system-mounting apparatus, or both the component system and the slidable component-system-mounting apparatus, and through which a first set of cables connected to ports on the component system are routed from the component system to the first structural member; and
a second, upper articulated-cable-management arm that is pivotably attached to a second structural member of the multi-component-system rack and pivotably attached to one of the component system, a slidable component-system-mounting apparatus, or both the component system and the slidable component-system-mounting apparatus, and through which a second set of cables connected to ports on the component system are routed from the component system to the second structural member.

10. The cable-management system of claim 9 wherein the first set of cables include power cables and the second set of cables include communications cables.
